(19) United States
(12) Patent Application Publication
(10) Pub. No.: US 2016/0186706 A1
(43) Pub. Date: Jun. 30, 2016

(54) SYSTEMS AND METHODS FOR FUEL STATE CONTROL WITH FUEL RECIRCULATION AND PREHEAT

(71) Applicant: BRAZIL GREEN ENERGY TECHNOLOGIES, LLC, Scottsdale, AZ (US)

(72) Inventors: Matthew Hawley, Scottsdale, AZ (US); Todd Thibault, Scottsdale, AZ (US); Alan Gill, Prior Lake, MN (US); Nathan James Heitzinger, Phoenix, AZ (US)

(21) Appl. No.: 14/800,441

(22) Filed: Jul. 15, 2015

Related U.S. Application Data
(60) Provisional application No. 62/024,904, filed on Jul. 15, 2014.

(51) Int. Cl. F02M 37/00; F02M 37/22

(52) U.S. Cl. CPC F02M 37/0052; F02M 37/223

(57) ABSTRACT

A method of recirculating high temperature fuel used as a coolant and lubricant in the engine to a fuel state control system is provided. The method may decrease the need for a heater component in the fuel state control system. The combination of the fuel recirculation and the use of a fuel state control system may increase the engine efficiency and decrease the emission of pollutants.

### CROSS-REFERENCE

This application claims priority to U.S. Provisional Patent Application Ser. No. 62/024,904 filed Jul. 15, 2014, which is entirely incorporated herein by reference.

### BACKGROUND

Manipulating the temperature, pressure, and physical state of a fuel before injection into an engine can alter the combustion process such that higher efficiency and lower emissions can be achieved. Control over a system designed to manipulate the fuel's temperature, pressure, and physical state may require advanced control systems and regulation. Current fuel state control systems require a heating element to increase the fuel temperature. The power requirements of the heating system may decrease the overall efficiency of the system.

### SUMMARY

In a traditional engine, fuel may be used to generate power. A fraction of the fuel may be used to cool and lubricate certain engine components. This fuel is left unburned after the combustion reaction occurs in the engine. Furthermore, this fuel may experience a measureable temperature rise as a result of heat transfer from hot engine surfaces. A fuel state control system may be configured to manipulate the temperature, pressure, and physical state of the fuel that is burned in the engine for power generation. Manipulation of the fuel properties before injection into the engine can alter the engine efficiency and pollutant emissions.

Provided herein is a method for redirecting return fuel to a fuel state control system (e.g. FUELXX®), where return fuel may be fuel that was used for cooling and lubricating engine components and may experience a temperature increase from heat transfer from the engine components. Return fuel may be at a higher temperature than fuel from the fuel tank and thus can be mixed to achieve the desired FUELXX® temperature. The recirculation of the high temperature return fuel into the fuel state control system may eliminate the need for a heating element in the fuel state control system. Alternatively the recirculation of the high temperature fuel may reduce the necessary power to the heating element or the duration of time the heating element needs to operate at each engine cycle. The recirculation system and method discussed herein may comprise a sophisticated control system which may be fully or partially automated. The control system may comprise a system of electrical components, sensors, switches, and valves.

An aspect of the invention is directed to a method of recirculating return high temperature fuel from an engine to a fuel state control system, said method comprising: dividing, with aid of a proportional valve, the return high temperature fuel into a first fuel stream that flows to the fuel state control system and a second fuel stream that flows to a fuel tank; and altering, using the fuel state control system, temperature and pressure of fuel from the first fuel stream mixed with fuel from the fuel tank, thereby increasing efficiency and decreasing emissions during a combustion reaction of the engine.

Further aspects of the invention are directed to a fuel recirculation system for recirculating return high temperature fuel from an engine to a fuel state control system, said system comprising: a proportional valve configured to divide the return high temperature fuel into a first fuel stream that flows to the fuel state control system and a second fuel stream that flows to a fuel tank; and the fuel state control system configured to alter the temperature and pressure of fuel from the first fuel stream mixed with fuel from the fuel tank, thereby increasing efficiency and decreasing emissions during a combustion reaction of the engine.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a simplified schematic of a fuel flow path from a tank to an engine including a fuel state control system and a proportioning valve.

FIG. 2 shows a cross section of a fuel state control system.

FIG. 3 shows a detailed schematic of the fuel flow path and relevant system components.

FIG. 4 shows the fuel flow path and electrical connections between system components.

FIG. 5 shows a schematic of a proportional valve in communication with a microprocessor and a temperature sensor.

FIG. 6 shows the fuel flow path including both the path of fuel combusted in the engine and the recirculation of return fuel.

FIG. 7 shows the components and connections of the control system, including an example of a user interface.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

This disclosure provides a system of recirculating fuel to a fuel state control system, the recirculated fuel may be heated by heat transfer from an engine prior to entering the fuel state control system. The recirculated fuel may be introduced into a fuel state control system to eliminate or decrease the need for activation of a heating element, thereby increasing the efficiency of the system. Various aspects of the described disclosure may be applied to any of the applications identified herein. It shall be understood that different aspects of the invention may be appreciated individually, collectively, or in combination with each other.

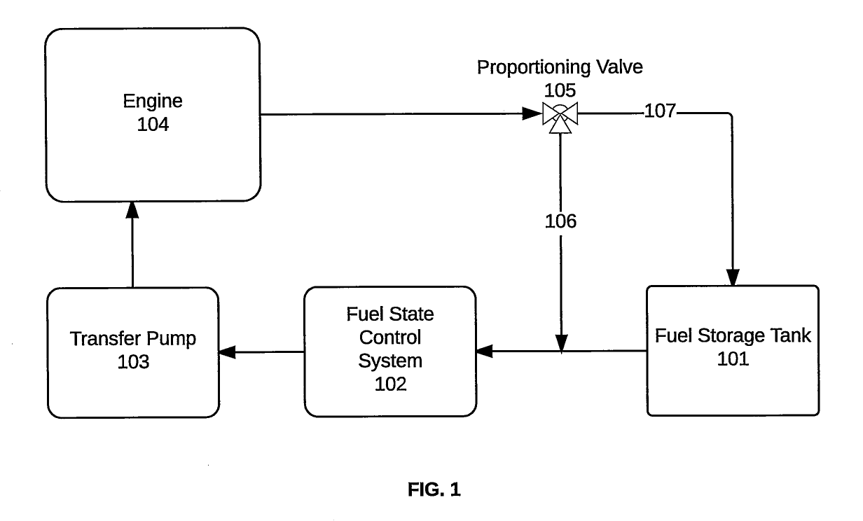

FIG. 1 shows a fuel recirculation system for use with a fuel state control system. An example of a fuel state control system is described in U.S. Patent Publication No. 2010/0012102 which is hereby incorporated by reference in its entirety. The fuel state control system may increase engine efficiency and decrease emission of pollutants from an engine combustion process. The system may move fuel from a fuel storage tank 101 to a fuel state control system (e.g. FUELXX®) 102. The fuel state control system may manipulate the temperature, pressure, and/or other characteristics of the fuel before sending it to the engine. In the schematic shown in FIG. 1, the fuel state control system may be installed on the low pressure (suction) side of the fuel system (e.g., before an engine transfer pump); alternatively, the fuel state control system may be installed on the high pressure side of the fuel system (e.g., after the engine transfer pump).

Before or after manipulation of the temperature, pressure, flow, air content, and/or other characteristics in the fuel state control system, the fuel may be pumped to the engine 104 by a transfer pump 103. The engine may be part of a vehicle as described in greater detail elsewhere herein. The engine may include one or more fuel injectors. In some instance, the fuel may be received by the fuel injectors. In addition to the fuel that enters the fuel injectors, a fraction of the fuel may also be used for lubrication and cooling of the fuel system components. This fraction of the fuel may absorb heat from the engine such that the temperature of the fuel in this fraction may increase. Some of this fuel may be sent back to the tank to mix with the lower temperature fuel stored in the tank. Additionally some of this fuel may be sent directly to the fuel state control system to take advantage of the fuel's increased temperature from the engine heat. This fuel may be referred to herein as return fuel. The division of the return fuel fraction to the tank or to the fuel state control system may be performed by a mixing or proportioning valve 105. The proportioning valve 105 may connect to two possible fuel paths, one going to the fuel state control system 106 and another path returning to the fuel tank 107. The proportional valve may be controlled mechanically or electronically.

A road vehicle, or stationary or marine application, employing the system described in FIG. 1 may have a fuel tank 101 for fuel storage. The fuel tank may be metallic (e.g. aluminum, steel, or iron), plastic, composite, or any combination thereof. The fuel tank may have a volume of at least 1 gallon, 5 gallons, 10 gallons, 15 gallons, 20 gallons, 30 gallons, 40 gallons, 50 gallons, 60 gallons, 70 gallons, 80 gallons, 90 gallons, or 100 gallons. The fuel stored in the tank for use in the system described in FIG. 1 may be diesel, gasoline, biodiesel, liquefied natural gas (LNG), compressed natural gas (CNG), methanol, ethanol, butanol, kerosene, or jet fuel. The fuel may be a liquid fuel or a gaseous fuel. The fuel may remain in the same state throughout a recirculation system or may alter between states (e.g., between a liquid and a gaseous state). The vehicle may have one or more fuel tanks The fuel tank may be configured to store fuel at a pressure of at least 1 atm, 2 atm, 3 atm, 4 atm, 5 atm, 10 atm, 15 atm, 20 atm, 30 atm, 40 atm, or 50 atm. The road vehicle, or stationary or marine application, may employ the engine 104 to operate the vehicle or application. The engine may be used to drive propulsion or activity of the vehicle or application.

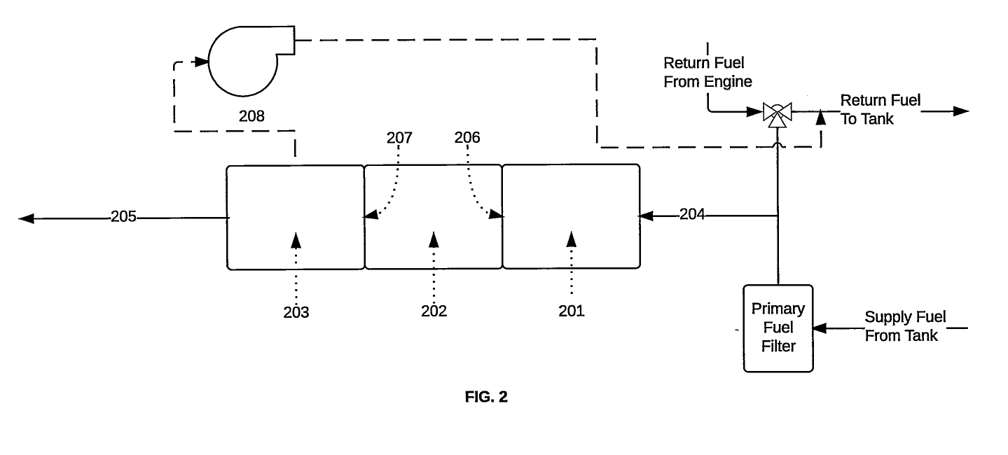

After exiting the tank, the fuel may be cleaned by flowing through a primary fuel filter, e.g. as illustrated in FIG. 2. The fuel filter may be a high, low, or medium efficiency filter. The filter may remove water or other liquid impurities from the fuel. Furthermore the fuel filter may remove solid particulates from the fuel, such as dust, paint chips, metal fragments, dirt, sand, or rust particles.

A fuel state control system 102 may be placed in the fuel delivery path after the primary fuel filter. The fuel state control system may alter the temperature and/or the pressure of the fuel prior to injection into the engine. Optionally, other characteristics of fuel may be altered prior to injection into the engine. An example of a fuel state control system is shown in FIG. 2. The fuel state control system shown in FIG. 2 has three chambers 201, 202, and 203. The three chambers may be a heating chamber or mixing chamber 201, a pressure chamber or expansion chamber 202, and a separation chamber 203. Fuel may enter the fuel state control system at an inlet 204 and exit at an outlet 205. The fuel state control system may be able to accommodate a flow rate of at least 5 gallons/hour, 10 gal/hr, 15 gal/hr, 20 gal/hr, 25 gal/hr, 30 gal/hr, 35 gal/hr, 40 gal/hr, 50 gal/hr, 60 gal/hr, 70 gal/hr, 80 gal/hr, 90 gal/hr, 100 gal/hr, 110 gal/hr, 120 gal/hr, 130 gal/hr, 140 gal/hr, 150 gal/hr, 160 gal/hr, 170 gal/hr, 180 gal/hr, 190 gal/hr, or 200 gal/hr. The fuel state control system may be able to accommodate a flow rate less than any of the values described, or within a range between any two of the values described. The fuel state control system may operate to bring the fuel to a desired target temperature at the outlet 205. An example of a target temperature may be 60 F, 70 F, 80 F, 90 F, 100 F, 110 F, 115 F, 120 F, 125 F, 130 F, 135 F, 140 F, 145 F, 150 F, 160 F, 170 F, 180 F, 190 F, 200 F, 210 F, 220 F, 230 F, 240 F, or 250 F. The fuel at the outlet may be brought to a temperature falling within a predetermined temperature range of the target temperature. For example, the predetermined temperature range may be within ±1 F, ±5 F, ±10 F, ±15 F, ±20 F, ±25 F, or ±30 F of the target temperature.

The fuel state control system may have dimensions such that it may be sized for installation on board a vehicle or in limited spaces often found in close proximity to engines. The fuel state control system may have a round, oval, square, or rectangular cross section. In the case of a round cross section the fuel state control system may have a diameter of at least 1 in, 5 in, 15 in, 20 in, 25 in, 30 in, 35 in, 40 in, 45 in, 50 in, 60 in, 70 in, 80 in, or 100 in. The diameter of the fuel state control system may be less than or equal to any of the values described herein. In the case of a non-round cross section the relevant length scale may fall on or within the range of values listed for the possible diameters. The fuel state control system may have an overall length of at least 1 in, 5 in, 15 in, 20 in, 25 in, 30 in, 35 in, 40 in, 45 in, 50 in, 60 in, 70 in, 80 in, or 100 in. The length of the fuel state control system may be less than or equal to any of the values described herein.

In some instances, fuel that reaches the fuel state control system may be mixed. The fuel may be a mixture of fuel from a fuel tank and heated fuel from an engine that was diverted to the fuel state control system.

The heating chamber or mixing chamber 201 may optionally further mix unheated fuel from the fuel tank with heated fuel introduced from a recirculation system to achieve a uniform mixture temperature. The mixing chamber may achieve a target fuel temperature without the use of a heating component. Alternatively, the mixing chamber may use a heating component to achieve a target temperature. In some instances a heating component may be provided and selectively used to supplement heat added by the heated fuel from the engine. In some embodiments, little or no alteration to the pressure of fuel may occur in the mixing chamber 201. For instance, the pressure of the fuel in chamber 201 may vary by less than 1%, 3%, 5%, 7%, or 10%.

Chamber 202 may be structurally and thermally isolated from chamber 201 by a divider 206. Optionally, one or more inlets may permit passage of fuel between chamber 201 and chamber 202. A single passageway or multiple passageways may be provided between the chambers to allow fuel to flow from chamber 201 to chamber 202. Chamber 202 or chamber 203 may comprise a temperature sensor. Furthermore, chamber 202 may comprise additional heating elements. Chamber 202 may serve as a backup unit in the event that the target temperature is not achieved in the heating chamber or mixing chamber 201. In some embodiments, little or no alteration to the pressure of fuel may occur in the chamber 202. For instance, the pressure of the fuel in chamber 202 may vary by less than 1%, 3%, 5%, 7%, or 10%. In some embodiments, little or no alteration to the pressure of the fuel may occur between chambers 201 and 202. For instance, the difference in pressure of the fuel in chambers 201 and 202 may be less than about 1%, 3%, 5%, 7%, or 10%.

Fuel may flow from pressure chamber or expansion chamber 202 to separation chamber 203 by means of a pressure plate 207. Optionally, one or more inlets may permit passage of fuel between chamber 202 and chamber 203. A single passageway or multiple passageways may be provided between the chambers to allow fuel to flow from chamber 202 to chamber 203. The fuel in chamber 203 may be further expanded such that a fraction of the fuel transitions from the liquid state to the gaseous state. Additionally, certain air that is dissolved or entrained in the fuel in chamber 203 may be separated by way of Henry's Law, resulting in a denser more pure fuel. In order to avoid separated air exiting through outlet 205, separated air accumulated in chamber 203 may be evacuated by way of a purge pump 208, the outlet of which is routed back to the fuel tank. The purge pump may be an optional feature and may or may not be included. The purge pump 208 may pull the air/fuel mixture from chamber 203 by way of a purge tube located above outlet 205. The purge pump may return the air/fuel mixture straight back to the fuel tank or it may tee into the return fuel line (illustrated), provided that the tee is downstream of the proportional valve on the fuel tank side. Cavitation may occur in chamber 202 or chamber 203. Pressure of the fuel may decrease within the expansion chamber. In some instances, pressure may decrease by at least 1%, 5%, 10%, 15%, 20%, 25%, 30%, 40%, or 50%.

The fuel exiting the fuel state control system may be analyzed by an inline temperature sensor. The fuel temperature sensor may be in communication with an electronic control system which may regulate the outlet temperature from the fuel state control system to achieve a desired target temperature. The temperature sensor may be in electronic communication with a valve, such as a solenoid actuated diverter valve or proportional valve, by means of the electronic control system. The temperature reading obtained from the temperature sensor may alert the electronic control system to adjust the valve such that the amount of recirculated fuel diverted directly to the fuel state control system relative to the amount of fuel routed to the fuel tank may be modulated.

A failsafe bypass system may be utilized to circumvent the fuel state control system under certain circumstances. A valve, such as a solenoid actuated diverter valve, may be controlled by means of a flow sensing switch or an electronic level switch could be used typically in the third chamber 203. If the flow sensing switch installed after the purge pump 208 does not have adequate flow, it could utilize the automatically activated failsafe bypass system to ensure little or no accumulation of air in chamber 203 enters the engine fuel system. Once the flow sensing switch again senses flow, and the accumulated air may be purged, the bypass could de-energize and the system would resume processing fuel.

After exiting the fuel state control system 102 and passing through the temperature sensor the fuel can be pumped to the engine by a transfer pump 103. The transfer pump may increase the pressure of the fuel. The final pressure of the fuel leaving the transfer pump may be determined by the necessary engine specifications.

An alternate configuration could include an auxiliary fuel pump to overcome any unacceptable restriction caused by the fuel state control system. This pump could be located anywhere in the circuit, that is before or after or in the interior of fuel state control system. This pump may also serve the purpose of enhancing the performance of the engine lift pump and reducing the fuel consumed. The pump could also support the fuel state change created within the fuel state control system. The addition of this pump may eliminate the need for or viability of the air pump. These choices can be dependent on the particular application of the fuel state control system.

A fraction of the fuel is used for cooling and lubrication and a fraction is used in the engine to generate power. The fuel pumped to the engine by the transfer pump may be introduced into the engine 104 for combustion and power generation. Flow of fuel may be controlled by an engine control module (ECM). The ECM may comprise one or more processors that may individually or collectively perform steps as described herein. The ECM may comprise one or more memory storage units that may comprise non-transitory computer readable medium, which may comprise code, logic or instructions for performing one or more steps as described herein. The ECM may control the amount of fuel injected into the engine, the time of fuel injection, the time of ignition, and/or the idle speed. The ECM may be in electronic communication with other components on or off board the vehicle. For example, the ECM may communicate electronically with a temperature sensor, moisture sensor, and/or fuel density sensor. The ECM may be in communication with the proportional valve 105. The ECM fuel usage may be communicated to the proportional valve, which may allow the valve to adjust the flow to the fuel state control system to achieve a desired temperature.

The ECM may command fuel be sent to the injectors in the engine 104 or any other component of the engine. Prior to injection the fuel may be routed through a secondary fuel filter. The secondary fuel filter may be a high, low, or medium efficiency filter. The filter may remove water or other liquid impurities from the fuel. Furthermore the secondary fuel filter may remove solid particulates from the fuel for example dust, paint chips, metal fragments, dirt, sand, or rust particles. After filtering, the fuel may enter the engine through a fuel injector where it may undergo a combustion reaction which may be used to generate power.

While fuel is reacting in the engine, a fraction of the fuel may by-pass the combustion process. This fraction, which may be as much as 85% of the total fuel going to the engine, may be used to remove excess heat from the engine and lubricate the engine components. After the combustion reaction in the engine, this fuel may cool the engine by absorbing excess heat and may then return to the fuel tank to mix with the lower temperature fuel. In the system described herein, some of this fuel may be diverted to the mixing chamber of the fuel state control system. A proportional valve may control flow of fuel in to a line leading to the mixing chamber 106 and a line leading to the fuel tank 107. The fuel may be diverted entirely into one of the fuel lines (107 or 106) or the fuel may be split evenly or unevenly between the two lines. The fraction of fuel in each line may vary with each engine cycle. The proportional valve may be able to adjust the fraction of fuel diverted to each line in real-time. Alternatively, the proportional valve may adjust or maintain the fraction of fuel periodically (e.g., every second, few seconds, minute, tens of minutes, hour) or in response to a detected event.

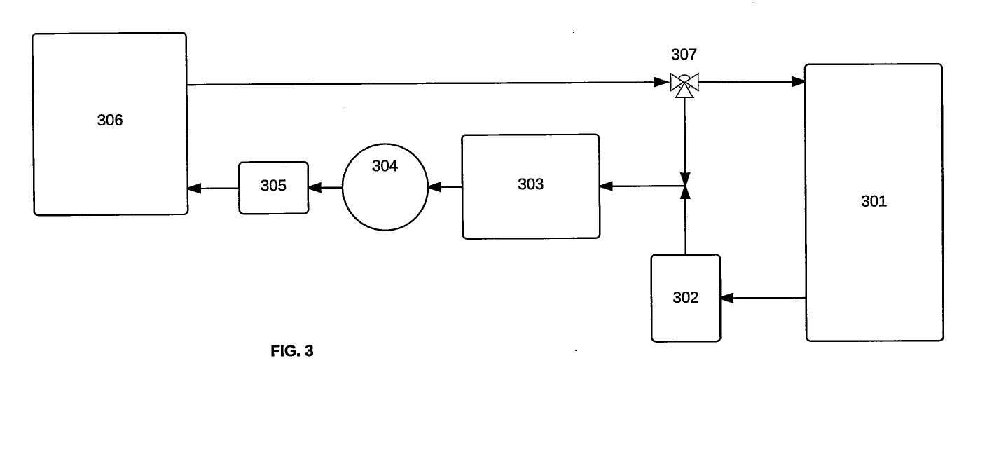

The overall flow path of the system is summarized in FIG. 3. In the diagram shown in FIG. 3, fuel may leave the tank 301 and can be routed through a primary filter 302. After removal of contaminants by the filter the fuel enters the fuel state control system 303 where it may undergo manipulation of temperature, pressure, or other characteristics resulting in a different state. Upon exiting the fuel state control system the fuel may be analyzed by a temperature sensor 304. Next the fuel is pumped by a transfer pump 305 to other engine components finally arriving at the engine 306. The ECM may control the timing and amount of fuel released from the fuel injectors into the engine. The ECM may or may not utilize an additional temperature sensor. Prior to entering the fuel injectors, the fuel may or may not pass through a secondary filter. In addition to the fuel burned in the engine, a fraction of the fuel may be removed from the tank and used for cooling and lubrication of the engine components, this fraction of fuel may be referred to herein as return fuel. The temperature of this fuel may increase as a result of absorbing heat from the engine during a heat exchange used to cool the engine. In a typical system the high temperature return fuel may be returned to the tank to mix with the colder fuel. In the system described herein, a portion of the high temperature return fuel may return to the fuel tank and a portion may be routed directly to the mixing chamber of the fuel state control system. Control over the percentage of the high temperature return fuel that returns to the tank compared to the percentage that is routed to the fuel state control system may be controlled by a flow control device, such as a proportional valve 307. The proportional valve may have an inlet and two outlets, one outlet leading to a line connecting to the fuel state control system and the other connecting to a path leading to the fuel tank. The proportional valve may comprise a poppet piston and a system of cylinders to meter flow between the two outlets.

The proportional valve 307 may be controlled mechanically or electronically. Mechanical control may comprise a system of springs or switches. In a preferred embodiment, the proportional valve 307 may be controlled electronically by a processor on-board or off-board the vehicle. The proportional valve 307 may be in electronic communication with the processor, additionally the processor may communicate with temperature and pressure sensors throughout the fuel recirculation system and the fuel state control system. The proportional valve, processor, and sensors may be in electronic communication wirelessly or they may be connected by wires. The proportional valve 307 may change the ratio of the fuel routed to the fuel state control system relative to the fuel tank in response to an input from the processor. The ratio may be constant for a given vehicle or the ratio may change periodically with time, driving conditions, or with each engine cycle. In some instances, the ratio may be about 1:1, 1:2, 1:3, 1:4, 1:5, 1:6, 1:7, 1:8, 8:1, 7:1, 6:1, 5:1, 4:1, 3:1, 2:1, 2:3, 3:2, 5:2, or 2:5. In most cases, for a temperature sensor between the fuel state control system 303 inlet and the engine 306, lower temperatures will result in processor demanding a higher ratio. In most cases, for a pressure sensor between the fuel state control system 303 inlet and the engine 306, lower pressures will result in processor demanding a higher ratio.

The introduction of the high temperature return fuel into the mixing chamber of the fuel state control system may eliminate the need for a heating component in the fuel state control system mixing chamber. The heating component may be eliminated completely from the mixing chamber or it may remain part of the fuel state control system and only be used under certain engine or environmental conditions, for example cold weather or prolonged low power use of the engine. Inclusion of the fuel recirculation system may require lower heating power of the heating element which may decrease the power consumed by the heating element and increase the efficiency of the system.

The flow recirculation system used to preheat fuel before introduction into the mixing chamber of the fuel state control system uses fuel which was used to cool and lubricate the engine components. Typical vehicle systems route a variable amount of fuel to the engine, of the amount routed to the engine a fraction is used as a reactant for combustion in the engine (burned fraction) and a fraction is used for cooling and lubricating the engine components (returned fraction). Most commonly the ratio of burned to returned fuel fractions is 1:2. Alternatively the ratio may be at least 1:1, 1:4, 1:5, 1:6, 1:7, 1:8, 8:1, 7:1, 6:1, 5:1, 4:1, 3:1, 2:1, 2:3, 3:2, 5:2, or 2:5.

The return fuel may be circulated from the engine to a proportional valve which may send the return fuel to the inlet of the fuel state control system mixing chamber. The return fuel may have an elevated temperature compared to the bulk of the fuel stored in the fuel tank. The return fuel may absorb heat from the engine when it is routed to the engine as a coolant which may result in a temperature increase. The return fuel may be used as a coolant to absorb heat from the engine components, the heat may be transferred from the engine components to the return fuel by any combination of convection, conduction, or radiation. The return fuel may experience a temperature increase of at least 1 F, 5 F, 10 F, 20 F, 30 F, 40 F, 50 F, 60 F, 70 F, 80 F, 90 F, or 100 F. A proportional valve may meter the flow of the return fuel. The proportional valve may route a fraction of the return fuel directly to the inlet of the fuel state control system mixing chamber. The remaining fraction of the return fuel may be routed back to the fuel tank by the proportional valve. The return fuel that returns to the fuel tank may be a small volume compared to the fuel tank volume such that when the return fuel fraction mixes with the lower temperature fuel in the tank the overall temperature fluctuation of the fuel in the tank is minimized.

The proportional valve may be part of a control system which provides electronic communication with one or more temperature sensors. For example the proportional valve may communicate with a temperature sensor at the outlet of the expansion chamber of the fuel state control system. The outlet temperature of the expansion chamber of the fuel state control system may be dependent on the temperature of the fuel in the mixing chamber of the fuel state control system. Therefore, the proportional valve may divert a fraction of the high temperature return fuel to the mixing chamber in response to the temperature reading from the outlet of the expansion chamber of the fuel state control system. The proportional valve may meter the fraction of high temperature return fuel entering the mixing chamber of the fuel state control system such that the temperature reading from the outlet of the expansion chamber of the fuel state control system falls within an acceptable range of a target temperature. An acceptable range may be at least within ±0.1 F, ±0.5 F, ±1 F, ±5 F, ±10 F, ±15 F, ±20 F, ±25 F, or ±30 F of the target temperature. The target temperature may be chosen to optimize physical properties of the fuel for example viscosity, density, heat capacity, surface tension, or solubility. Additionally the target temperature may be chosen such that cavitation occurs at a location in the fuel path. Examples of possible target temperatures are at least 80 F, 90 F, 100 F, 110 F, 120 F, 130 F, 140 F, 150 F, 160 F, 170 F, 180 F, 190 F, 200 F, 210 F, 220 F, 230 F, 240 F, or 250 F. Target temperature may be modulated dynamically based on the fuel being used by the engine.

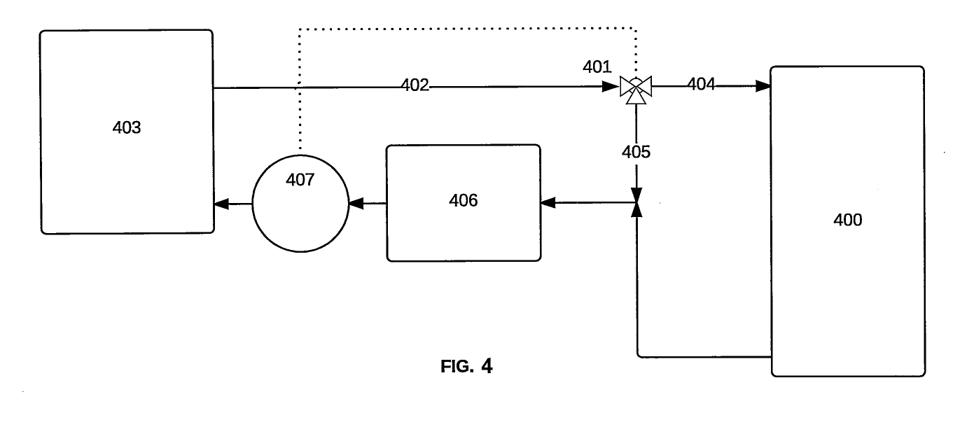

FIG. 4 shows a diagram of the control system communication between temperature sensors and the proportional valve. The control system may be provided on-board a vehicle. Examples of a vehicle may be a car, truck, motorcycle, van, bus, or scooter. The vehicle may include one or more fuel tanks 400. The vehicle may be manufactured with the fuel recirculation system or the vehicle may have one or more the components of the system installed after market. The diagram shows a proportional valve 401 receiving high temperature return fuel from a fuel return line 402 connected to the engine 403. The proportional valve may have two outlet lines, a tank return line 404 and a fuel state control line 405. The tank return line 404 returns fuel to the tank and the fuel state control line 405 routes fuel to the fuel state control system 406. The proportional valve 401 is in electronic communication with the temperature sensor 407 at the outlet of the fuel state control system. The proportional valve may receive information from the temperature sensor, which the proportional valve may optionally use to determine how much fuel to apportion to the tank return line and/or the fuel state control line.

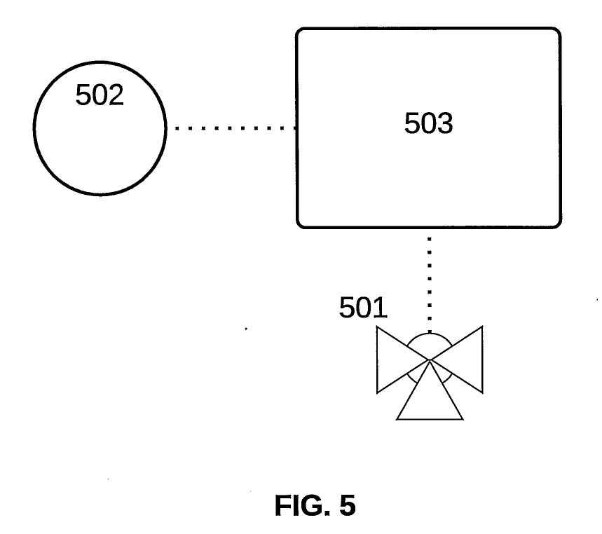

FIG. 5 shows a view of a proportional valve 501 that may be integrated into the system as described. The proportional valve 501 may be in communication with a temperature sensor 502. The temperature sensor 502 may be any temperature sensor configured for the temperature range of interest, for example the sensor may be a thermocouple, temperature switch (bellows mechanism), thermistor, infrared sensor, or thermometer. The temperature sensor reading may be in communication with a microprocessor 503. The microprocessor may be adjacent to the proportioning valve or removed from the system and connected to the proportioning valve by an electrical path. The microprocessor may control the ratio of high temperature return fuel sent to the mixing chamber of the fuel state control system relative to the fuel tank. The proportioning valve may allow any fraction of the high temperature return fuel to return to the tank in response to the microprocessor control system. The proportioning valve may allow any fraction of the high temperature return fuel to be diverted directly to the mixing chamber of the fuel state control system in response to the microprocessor control system. If any of the control system components fail or break down (e.g. the temperature sensor or microprocessor), the default case may be for the proportional valve to allow all of the high temperature return fuel to return to the tank.

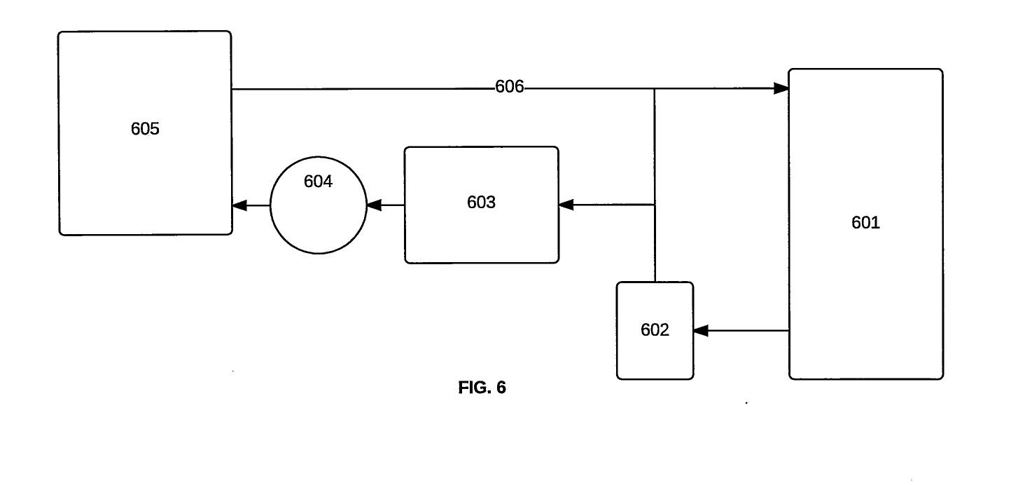

FIG. 6 shows an example of a complete fuel flow path. FIG. 6 describes a closed loop, the fuel path may be considered as beginning in the fuel tank 601. Fuel stored in the tank may have a temperature comparable to an ambient temperature, for example the fuel in the tank may have an initial temperature about equal to the ambient temperature. Fuel may exit the tank and pass through a primary filter 602. Next the fuel may enter a fuel state control system 603. Prior to entering the fuel state control system the fuel may be mixed with high temperature recirculated return fuel. The mixture of fuel from the tank and high temperature recirculated return fuel may have a final temperature between 40 F and 300 F, preferably the temperature may be between 60 F and 140 F. The fuel mixture may enter the fuel state control system, upon exiting the fuel state control system the fuel may have a temperature corresponding to a desired target temperature. Examples of possible target temperatures are at least 80 F, 90 F, 100 F, 110 F, 120 F, 130 F, 140 F, 150 F, 160 F, 170 F, 180 F, 190 F, 200 F, 210 F, 220 F, 230 F, 240 F, or 250 F. The fuel may then be routed to the engine by a fuel transfer pump. The fuel may have an increased temperature at the transfer pump exit, the fuel temperature may increase by as much as 0.1 F, 0.5 F, 1 F, 5 F, 10 F, 15 F, 20 F, 25 F, 30 F, 40 F, or 50 F. Next the fuel may enter the engine 605 by means of the injection pump 604. The fuel may be burned in the engine to generate power. While the fuel is being consumed in the engine ambient temperature fuel from the fuel tank 601 may be used to cool and lubricate the engine. The temperature of this fuel may increase due to transfer of heat from the engine components. The temperature of this fuel after the combustion reaction may be 80 F, 90 F, 100 F, 110 F, 120 F, 130 F, 140 F, 150 F, 160 F, 170 F, 180 F, 190 F, 200 F, 210 F, 220 F, 230 F, 240 F, or 250 F. The heated fuel may be sent back to the system via a return line 606. A fraction of the fuel may return to the tank 601 and a fraction may be mixed with fuel entering the fuel state control system 603.

The fuel recirculation system may comprise a plurality of safety and control systems. For example the fuel recirculation system may comprise a Zener diode or another current control component. The Zener diode may activate the fuel state control system when the engine is running The Zener diode may sense the vehicle alternator output voltage indicating that the engine is running In response to the sensed alternator output voltage the Zener diode may activate a relay. The relay may be any available relay, for example a 10 amp, 20 amp, 30 amp, 40 amp, 50 amp, 60 amp,70 amp, 80 amp, 90 amp, or 100 amp relay. For example the Zener diode may activate a relay to control the proportional valve. In another example the Zener diode may activate a relay to provide power to a heater in the mixing chamber of the fuel state control system. The relay may regulate the heater temperature to maintain a target fuel temperature in the mixing chamber. A target temperature may be chosen based on a safety or performance standard. For example, a target temperature may be at least 150 F, 160 F, 170 F, 180 F, 190 F, 200 F, 210 F, 220 F, 230 F, 240 F, 250 F, 260 F, 270 F, or 280 F, 290 F, 300 F, or 310 F, 320 F, 330 F, 340 F, or 350 F. Fuel recirculation may eliminate the need for a heater element in the mixing chamber.

The fuel recirculation system may comprise a control system. The control system may include hardware and software configured to regulate the system components. The control system may regulate the proportional valve such that the fraction of high temperature return fuel routed directly to the fuel state control system mixing chamber permits the system to achieve the desired target temperature at the outlet of the fuel state control system. The control system may be in electronic communication with the proportional valve wirelessly or through wired connections. The control system may include the processor used to control the proportional valve in addition to other components. The processor may control the proportional valve in response to non-transitory computer readable media comprising code, logic, or instructions for performing one or more steps. The control system may comprise memory that may include the non-transitory computer readable media. The control system may determine the fraction of high temperature return fuel routed directly to the fuel state control system mixing chamber based on a variety of input parameters pertaining to the engine conditions, ambient conditions, and current conditions in the fuel state control system. For example an input parameter may be the ambient temperature, fuel type, altitude, engine speed, engine load, and the temperature reading from any point in the fuel flow path. For example, if a temperature sensor at an exit point of the fuel state control system exceeds a target temperature by a predetermined amount, then control system may provide an instruction to the proportional valve to decrease the relative amount of fuel being diverted to the fuel path that returns to the fuel state control system and increase the relative amount of fuel being diverted to the fuel path that returns to the tank. Similarly, if a temperature sensor at an exit point of the fuel state control system falls beneath a target temperature by a predetermined amount, then control system may provide an instruction to the proportional valve to increase the relative amount of fuel being diverted to the fuel path that returns to the fuel state control system and decrease the relative amount of fuel being diverted to the fuel path that returns to the tank.

The control system may be in electronic communication with the proportional valve. The electronic communication may be achieved through a SAE J1708 or J1939 or OBDII bus. Alternatively another bus or connection may be used to connect the control system to the proportional valve electronically. The proportional valve may be configured to communicate with any analog or SAE J1708 or J1939 or OBDII operator interface device, for example a joystick, potentiometer, sensor, or a master controller.

A user interface may be provided so that a user may monitor the system temperatures at various points in the fuel flow path. The user interface may communicate with a processor, valve, or sensor in the fuel recirculation system wirelessly or through a wired connection, the connection may be a CAN communication bus. The user interface may also allow the user to monitor the current conditions, for example the user interface may indicate the fraction of high temperature return fuel routed directly to the fuel state control system mixing chamber. Additionally the user interface may display the engine temperature, vehicle speed, average miles per gallon (MPG), fuel line temperature at various locations, ambient temperature, remaining fuel in tank, average engine efficiency, average fluctuation of temperature at various points in the recirculation system or any number of other parameters available from the diagnostic bus. The user interface may provide an additional safety feature by allowing the user to monitor the temperature of the fuel in the system. The user interface may be configured to provide a visual or audible alarm if the system reaches an unsafe temperature at any point in the fuel lines or if the system efficiency drops below an expected range.

The user interface may display system diagnostics chosen by the user. The user interface may have a screen which is able to display one or more diagnostics or metrics simultaneously. A user may be able to toggle between different screens showing different metrics. The screen may be 2 in, 3 in, 4 in, 5 in, 6 in, 7 in, 8 in, 9 in, 10 in, 15 in, or 20 in wide. The user interface may comprise a video input. A user may or may not be able provide an input that may alter the proportion of the heated fuel that is returned to the fuel state control system. A user may or may not be able to provide an input that may result in maintenance or variance of the proportional valve. The user interface may be programmable using a common coding language for example Java-based languages. The user interface may be installed in the system after market or the user interface may be integrated with a user interface built into the vehicle, for example a user interface intended for use with a factory installed GPS system.

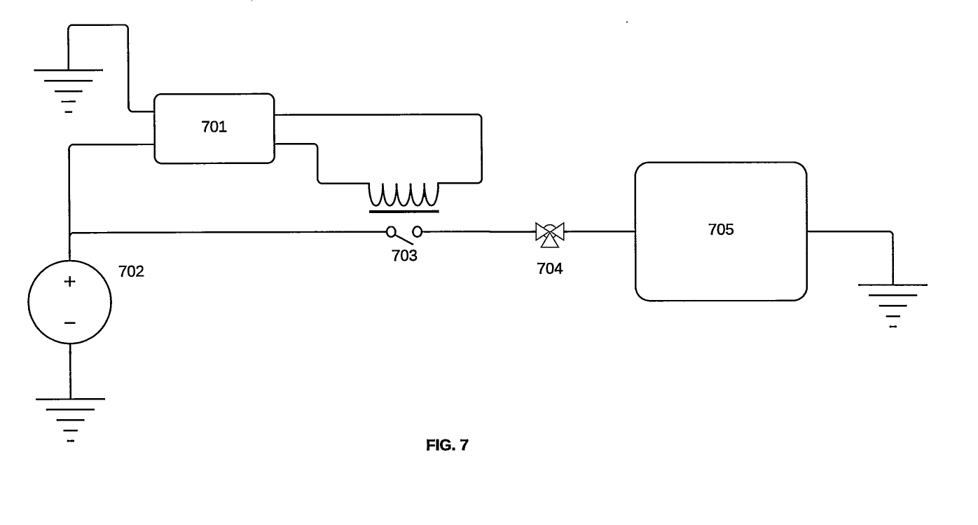

FIG. 7 provides a schematic overview of the system components and the relevant electrical connections and control systems. The components may be in electronic communication wirelessly or through wired connects. The Zener diode 701 is shown in communication with a vehicle battery 702. The Zener diode may recognize a battery voltage when the vehicle is in use and may activate the fuel recirculation system. The Zener diode may also be in electric communication with one or more relay systems as shown. Relay 703 may activate the proportional valve 704. The proportional valve may apportion fuel between two or more possible fuel paths, such as those described elsewhere herein. The proportional valve 704 may also be in electronic communication with the fuel recirculation control system 705. The fuel recirculation control system may optionally include a user interface. The user interface may have an LED display, may be a touch screen, or may be an LCD display. The user interface may show information relating to the fuel recirculation system, such as temperature, pressure, or other fuel characteristic readings at any of the components described herein. The user interface may show information relating to fuel usage, mileage per gallon, efficiency, distance traveled, fuel remaining, or any other information relating to the vehicle fuel system.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method of recirculating return high temperature fuel from an engine to a fuel state control system, said method comprising:
dividing, with aid of a proportional valve, the return high temperature fuel into a first fuel stream that flows to the fuel state control system and a second fuel stream that flows to a fuel tank; and
altering, using the fuel state control system, temperature and pressure of fuel from the first fuel stream mixed with fuel from the fuel tank, thereby increasing efficiency and decreasing emissions during a combustion reaction of the engine.

2. The method of claim 1, wherein the fuel state control system comprises a first chamber, a second chamber, and a third chamber, wherein the first chamber is connected to the second chamber via one or more passageways, and the second chamber is connected to the third chamber via one or more passageways.

3. The method of claim 2, further comprising receiving fuel at the first chamber, and bringing the fuel to within a predetermined range of a target temperature.

4. The method of claim 3, wherein pressure of the fuel within the first chamber is varied by less than 10% while the fuel is brought to within the predetermined range of the target temperature.

5. The method of claim 3, further comprising receiving the fuel from the first chamber at the second chamber, wherein the second chamber comprises a temperature sensor and one or more heating elements configured to further heat the fuel when a determination is made, based on data gathered by the temperature sensor, that further heating is required to achieve a predetermined range of a desired temperature.

6. The method of claim 5, wherein pressure of the fuel within the second chamber is varied by less than 10% while the fuel is brought to within the predetermined range of the desired temperature.

7. The method of claim 5, further comprising receiving the fuel from the second chamber at the third chamber, and separating air in the fuel from the remainder of the fuel within the third chamber.

8. The method of claim 7, further comprising evacuating the air from the third chamber with aid of a purge pump.

9. The method of claim 8, further comprising measuring a degree of flow after the purge pump, and preventing an accumulation of air within the third chamber from entering a flow of fuel to the engine when the degree of flow falls beneath a predetermined threshold.

10. The method of claim 5 further comprising receiving the fuel from the second chamber at the third chamber, and permitting cavitation to occur within the third chamber.

11. The method of claim 10 wherein pressure of the fuel within the third chamber is decreased by more than 5%.

12. The method of claim 1 wherein the proportional valve divides the return high temperature fuel based on a measurement from a temperature sensor or a pressure sensor within the fuel state control system.

13. The method of claim 1 further comprising selecting a ratio for the proportional valve to divide the return high temperature fuel to cause the fuel entering the fuel state control system to fall within a predetermined temperature range of a target temperature.

14. A fuel recirculation system for recirculating return high temperature fuel from an engine to a fuel state control system, said system comprising:
a proportional valve configured to divide the return high temperature fuel into a first fuel stream that flows to the fuel state control system and a second fuel stream that flows to a fuel tank; and
the fuel state control system configured to alter the temperature and pressure of fuel from the first fuel stream mixed with fuel from the fuel tank, thereby increasing efficiency and decreasing emissions during a combustion reaction of the engine.

15. The system of claim 14, wherein the fuel state control system comprises a first chamber, a second chamber, and a third chamber, wherein the first chamber is connected to the second chamber via one or more passageways, and the second chamber is connected to the third chamber via one or more passageways.

16. The system of claim 15, wherein the fuel state control system is configured to separate air from the remainder of the fuel within the third chamber, and evacuate the air from the third chamber with aid of a purge pump.

17. The system of claim 14 further comprising a primary fuel filter configured to remove impurities or particulates from the fuel between the fuel tank and the fuel control system.

18. The system of claim 14 further comprising a transfer pump between the fuel state control system and the engine configured to pump fuel from the fuel state control system to the engine.

19. The system of claim 14 further comprising an engine control module configured to control the fuel provided to the engine, wherein engine control module fuel usage information may be communicated to the proportional valve and may affect operation of the proportional valve in dividing the return high temperature fuel.

20. The system of claim 14 wherein the proportional valve divides the return high temperature fuel based on a measurement from a temperature sensor or a pressure sensor within the fuel recirculation system.
